(19) United States
(12) Patent Application Publication
(10) Pub. No.: US 2011/0262605 A1
(43) Pub. Date: Oct. 27, 2011

(54) METHOD OF PREPARING DRIED PRE-GELATINIZED RICE

(75) Inventors: Ye Jin OH, Suwon-si (KR); Tae Hyeong KIM, Suwon-si (KR)

(73) Assignee: CJ CHEILJEDANG CORP., Seoul (KR)

(21) Appl. No.: 12/833,266

(22) Filed: Jul. 9, 2010

(30) Foreign Application Priority Data
Apr. 27, 2010 (KR) 10-2010-0039170

(51) Int. Cl. A23L 1/18

(52) U.S. Cl. 426/450

(57) ABSTRACT

A method of preparing dried pre-gelatinized with excellent restoration characteristics and good texture is disclosed.

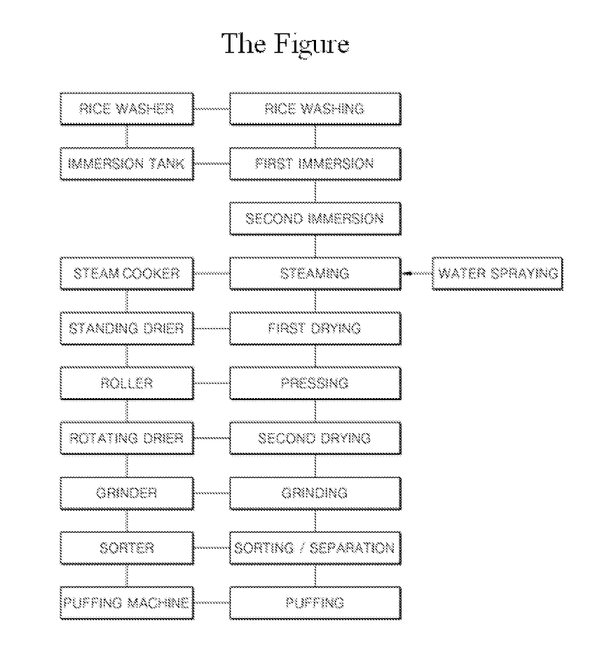

### CROSS-REFERENCE TO RELATED PATENT APPLICATION

This application claims the benefit of Korean Patent Application No. 10-2010-0039170, filed on Apr. 27, 2010, in the Korean Intellectual Property Office, the disclosure of which is incorporated herein in its entirety by reference.

### BACKGROUND OF THE INVENTION

1. Field of the Invention

The present invention relates to a method of preparing dried pre-gelatinized rice with excellent restoration characteristics and good texture.

2. Description of the Related Art

Various ready-to-eat foods which can be conveniently used during the busy daily life or leisure activities have been developed. Generally, ready-to-eat foods refer to foods that are easily cooked for a short period of time and easily stored and preserved, and can be conveniently carried. Dried pre-gelatinized rice is an example of a ready-to-eat food, and refers to dried rice whose major component, starch is converted from a beta type from an alpha type when boiling water is added thereto, or when cooked in a microwave oven after water is added thereto. Dried pre-gelatinized rice has the same texture and restoration characteristics as cooked rice without cooking process.

According to a conventional method of preparing dried pre-gelatinized rice, rice is immersed in water for a long period of time and then steam cooked, or cooked after water is added thereto, and then the pre-gelatinized rice is dried by hot air current until the amount of water contained in the rice becomes 10% or less. The dried rice can be stored for a long period of time because of its low water content.

Pre-gelatinization is achieved by converting beta type starch in which starch molecules are regularly arranged into alpha type starch on which water or enzyme may easily act. The beta type starch is easily converted into pre-gelatinized starch by heating it with 30% or more water content at a temperature of 100° C. for 20 minutes or more. However, if pre-gelatinized starch is left to cool down, starch molecules are re-converted into beta type starch by self aging. If the water content of pre-gelatinized starch is lowered to 15% or lower and the pre-gelatinized starch is dried, the conversion of alpha type into beta type is stopped, thereby maintaining a completely stabilized pre-gelatinization state. The rice prepared as described above is dried pre-gelatinized rice.

Conventionally prepared dried pre-gelatinized rice is restored before eating by keeping it in hot water in 10 minutes. However, in this case, the restoration is poor, hard rice grains are included, and most of the rice grains are broken, leading to bad texture. Accordingly, there have been many attempts to improve restoration characteristic and texture of dried pre-gelatinized rice. For example, various additives may be used when polished rice is immersed in water, or polished rice may be sufficiently pre-gelatinized to increase a degree of restoration when heated. However, when additives are added to polished rice, additional preparation costs may be required and used additives may remain in the rice, thereby affecting the texture of rice. When rice is cooked with addition of water instead of steam-cooked in order to achieve sufficient pre-gelatinization, it is difficult to separate pre-gelatinized rice grains individually and thus, when passed through a grinder after drying, all the pre-gelatinized rice grains are broken. Accordingly, there is still a need for dried pre-gelatinized rice that can be easily cooked and stored for a long period of time with excellent restoration characteristics and texture, and a method of preparing the same.

In response to such a need, the inventors of the present invention have continued studies to develop dried pre-gelatinized rice and a method of preparing the same, and discovered a method of preparing dried pre-gelatinized rice with excellent restoration characteristics and good texture, wherein temperature and time are controlled in an immersion process, water is added to rice by spraying in a steaming process, rolling is performed in a drying process, and puffing is performed in a final process.

### SUMMARY OF THE INVENTION

The present invention provides a method of preparing dried pre-gelatinized rice with excellent restoration characteristics and good texture.

### BRIEF DESCRIPTION OF THE DRAWINGS

The above and other features and advantages of the present invention will become more apparent by describing in detail exemplary embodiments thereof with reference to the single FIGURE which is a flowchart illustrating a method of preparing dried pre-gelatinized rice according to an embodiment of the present invention.

### DETAILED DESCRIPTION OF THE INVENTION

A method of preparing dried pre-gelatinized rice according to an embodiment of the present invention includes:
washing polished rices;
immersing the washed polished rice in high-temperature water at 40° C. to 70° C.;
immersing the polished rice that was immersed in the high-temperature water in low-temperature water at 10° C. to 30° C.;
dehydrating the polished rice that was immersed in the low-temperature water;
steaming the dehydrated polished rice, thereby preparing pre-gelatinized rice;
first-drying the pre-gelatinized rice;
pressing the first-dried pre-gelatinized rices by passing it through a rolling mill
separating the dried rice into individual rice grains;
second-drying the pressed pre-gelatinized rice
puffing the separated rice grains.

According to the method of preparing dried pre-gelatinized rice of the present invention, dried rice which is pre-gelatinized for ready-to-eat is puffed, thereby providing dried pre-gelatinized that can be preserved for a long period of time and has the same texture when restored using a microwave oven or hot water as the cooked rice.

According to an embodiment of the present invention, the washed polished rice may be immersed in the high temperature water for 1 hour to 4 hours.

According to an embodiment of the present invention, the polished rice that was immersed in the high-temperature water may be immersed in the low-temperature water for 30 minutes to 2 hours.

According to an embodiment of the present invention, the steaming is performed using steam at 95° C. to 100° C. in a steam cooker for 10 minutes to 30 minutes, while water is uniformly sprayed in the steam cooker.

In the steaming, the spraying of water leads to sufficient pre-gelatinization, and facilitates separation into rice grains after the steaming.

According to an embodiment of the present invention, in the drying, the pre-gelatinized rice is uniformly spread and first dried in a standing hot current drier at a temperature of 40 to 90° C.

According to an embodiment of the present invention, the first dried pre-gelatinized rice is pressed by passing it through a rolling miller with micro needles.

According to an embodiment of the present invention, the pressed pre-gelatinized rice is second-dried in a rotating hot current drier at a temperature of 40 to 90° C.

According to an embodiment of the present invention, the first-drying is performed for 2 to 4 hours, and the second-drying is performed for 1 to 2 hours.

When the first-drying by the standing hot current drier and the second-drying by the rotating hot current drier are performed, the drying time may be reduced compared when only the standing hot current drier is used. Although use of a rotating hot current drier results in a high drying efficiency, when used in the first-drying, the pre-gelatinized rice is blown and stuck to wall of the rotating hot current drier. Therefore, it is better to use a rotating hot current drier in the second-drying step after water at the surface of the pre-gelatinized rice is removed by using a standing hot current drier in the first-drying step.

When the first dried pre-gelatinized rice grains which are not completely dried and have some elasticity are passed through a roller such as a rolling mill between the first-drying and the second-drying, the pre-gelatinized rice grains are flattened to some extent. In this regard, when needles in a micro protrusion shape are mounted on a surface of the roller, micro pores on surfaces of the pre-gelatinized rice grains are formed after passed through the roller. Thus, water may much easily permeate into the pressed pre-gelatinized rice grains when restored after drying, and thus restoration may be achieved fast.

According to an embodiment of the present invention, in the separating, the second-dried pre-gelatinized rice is ground by passing it through a grinder and through a sorter. When rice is steamed with addition of water as in a conventional rice cooking method, the surface of pre-gelatinized rice becomes stickier. Thus, in a grinding process, pre-gelatinized rice grains may be broken and lumped. However, when steam is sprayed onto rice without addition of water for cooking in the steaming process as in embodiments of the present invention, the stickiness of the rice surface is not increased. Thus, during the grinding, pre-gelatinized rice grains are not lumped and easily separated individually.

According to an embodiment of the present invention, the puffing is performed at a temperature of 200 to 300° C. for 5 to 30 seconds, using a puffing machine.

An example of the method of preparing dried pre-gelatinized rice according to the present invention will now be described in detail.

Polished rice is washed by using a rice washer to remove foreign substances from the surface thereof and then transferred to an immersion tank and immersed in hot water at 40° C. to 70° C. for 1 to 4 hours. Then, the immersion water is exchanged with cold water at 10° C. to 30° C. and the polished rice is immersed therein for 30 minutes to 2 hours. In this regard, the immersion is continued until the water content of the final polished rice reaches 20 to 40%.

After the immersion process, the polished rice is dehydrated to remove excess immersion water, transferred to a rotating steam cooker to dehydrate excess immersion water and steamed using steam at 95° C. to 100° C. for 10 to 30 minutes. During the steaming, water is uniformly sprayed in a steam cooker once or twice. The water content of the final pre-gelatinized rice is controlled to be in the range of 30 to 60%.

After the steaming, the pre-gelatinized rice is uniformly spread in a wicker tray and is first dried in a standing hot current drier at a temperature of 40 to 90° C. for 2 to 4 hours. The first dried pre-gelatinized rice is pressed by passing it through a roller such as a rolling mill. In this regard, the surface of the roller has micro protrusions and thus surfaces of pre-gelatinized rice grains are punctured with micro pores formed thereon. The pre-gelatinized rice that passed through the roller is second-dried in a rotating hot current drier at a temperature of 40° C. to 90° C. for 1 to 2 hours. The drying is performed until the water content of the pre-gelatinized rice reaches 5 to 20%.

The dried pre-gelatinized rice is ground by using a grinder and the resulting rice grains are individually separated by passing them through a sorter.

Then, puffing is performed by using a puffing machine, at a temperature of 200° C. to 300° C. for 5 to 30 seconds.

The dried pre-gelatinized rice prepared as described above can be immediately restored by reheating it in a microwave oven or hot water.

The present invention will be described in further detail with reference to the following examples. These examples are for illustrative purposes only and are not intended to limit the scope of the present invention.

### Examples 1 to 4

Dried pre-gelatinized rice was prepared according to an embodiment of the present invention and effects of individual processes of the method are compared.

### Example 1

A control group was prepared by immersing polished rice in water at room temperature for 8 hours, and an experimental group was prepared by immersing polished rice in hot water at 40° C. to 70° C. for 1 to 4 hours. In order to compare an effect of the immersion process, a rice grain separation rate of the dried pre-gelatinized rice of the control group was compared with that of the dried pre-gelatinized rice of the experimental group. In addition, 160 g of water was added to 80 g of the dried pre-gelatinized rice of the control group and the pre-gelatinized rice of the experimental group and then that of the control group and the pre-gelatinized rice of the experimental group were cooked in a microwave oven. Then, restoration rates of the cooked dried pre-gelatinized rice in the two groups were compared.

### Example 2

A control group was prepared by immersing polished rice in hot water at 40° C. to 70° C. for 1 to 4 hours, and an experimental group was prepared by further immersing the polished rice that had been immersed in hot water as the control group in cold water at 10° C. to 30° C. for 30 minutes to 2 hours. In order to compare an effect of the immersion process, a rice grain separation rate of the dried pre-gelatinized rice of the control group was compared with that of the dried pre-gelatinized rice of the experimental group. In addition, 160 g of water was added to 80 g of the dried pre-gelatinized rice of the control group and the dried pre-gelatinized rice of the experimental group and then the dried pre-gelatinized rice of the control group and that of the experimental group were cooked in a microwave oven. Then, restoration rates of the cooked dried pre-gelatinized rice in the two groups were compared.

### Example 3

Control group 1 was prepared by cooking the immersed rice with water added thereto, with a vapor at a temperature of 95° C. to 100° C. for 30 minutes, control group 2 was prepared by steaming the immersed rice with a vapor at a temperature of 95° C. to 100° C. for 30 minutes in a steam cooker, and an experimental group was prepared using the same method using control group 2 except that water was sprayed to the rice one or more times during the steaming process. In order to compare an effect of the steaming process, rice grain separation rates of the dried pre-gelatinized rice of control groups 1 and 2 were compared with that of the dried pre-gelatinized rice of the experimental group. In addition, 160 g of water was added to 80 g of the dried pre-gelatinized rice of the control groups 1 and 2 and the experimental group and then the dried pre-gelatinized rice of the control groups 1 and 2 and the dried pre-gelatinized rice of the experimental group were cooked in a microwave oven. Then, restoration rates of the cooked dried pre-gelatinized rice in the three groups were compared.

### Example 4

A control group was prepared by performing second-drying immediately after first-drying in a drying process, and an experimental group was prepared by pressing it by a roller after first-drying and then performing second-drying. The roller was a rolling mill with micro protrusion needles on the roll surface. The first-drying and the second-drying were performed using a standing hot current drier and a rotating hot current drier, respectively. In order to compare an effect of the inclusion of a pressing process in the drying, rice grain separation rates of the dried pre-gelatinized rice of control groups 1 and 2 were compared with that of the dried pre-gelatinized rice of the experimental group. In addition, 160 g of water was added to 80 g of the dried pre-gelatinized rice of the control groups 1 and 2 and the experimental group and then the dried pre-gelatinized rice of the control groups 1 and 2 and dried pre-gelatinized rice of the experimental group were cooked in a microwave oven. Then, restoration rates of the cooked dried pre-gelatinized rice in the three groups were compared.

Rice grain separation rates and restoration rates of the dried pre-gelatinized rice prepared according to Examples 1 to 4 are shown in Table 1.

TABLE 1

| | | Rice grain separation rate | | | restoration rate | | |
|---|---|---|---|---|---|---|---|
| | | High | Moderate | Low | High | Moderate | Low |
| Example | Control | ⊙ | | | | | ⊙ |
| 1 | Group | | | | | | |
| | Experimental | | ⊙ | | ⊙ | | |
| | Group | | | | | | |
| Example | Control | | ⊙ | | ⊙ | | |
| 2 | Group | | | | | | |
| | Experimental | ⊙ | | | ⊙ | | |
| | Group | | | | | | |
| Example | Control | | | ⊙ | | ⊙ | |
| 3 | Group 1 | | | | | | |
| | Control | ⊙ | | | | ⊙ | |
| | Group 2 | | | | | | |
| | Experimental | ⊙ | | | ⊙ | | |
| | Group | | | | | | |
| Example | Control | ⊙ | | | ⊙ | | |
| 4 | Group | | | | | | |
| | Experimental | ⊙ | | | ⊙ | | |
| | Group | | | | | | |

the rice grain separation rate refers to a ratio of the weight of separated rice grains to the total weight o dried pre-gelatinized rice.
high: about 80%
moderate: 50 to 80%
low: below 50%
the restoration rate was evaluated based on results of a quick sensory test.
high: mostly restored
moderate: moderately restored
low: barely restored

Referring to Example 1, the dried pre-gelatinized rice prepared by immersing the polished rice for a long period of time in water at room temperature was not restored by cooking it in a microwave oven after water was added thereto. However, when the polished rice was immersed in high-temperature water, the dried pre-gelatinized showed excellent restoration characteristics. Referring to Example 2, when the immersion was performed only in high-temperature immersion water, pre-gelatinized rice grains were stuck to each other during steaming and their shapes were deformed, which is referred to as a stickiness phemanenon, and thus, the rice grain separation rate was reduced. Referring to Example 3, when cooking was performed together with addition of water, rice grains were pre-gelatinized sufficiently, however, the grains were not separated from each other, making it difficult for water to permeate into dried pre-gelatinized rice for restoration. Thus, restoration rate was reduced. Also, when steaming was performed without addition of water, pre-gelatinization was insufficiently achieved, and thus, restoration characteristics of the dried pre-gelatinized rice was not satisfactory. On the other hand, when steaming was performed together with spraying of water, the stickiness phemanenon did not occur, and thus, rice grains were easily separated and pre-gelatinization was sufficiently achieved and excellent restoration characteristics were obtained. Referring to Example 4 in which a drying process includes a pressing process, thickness of dried pre-gelatinized rice grains was reduced and the surfaces of rice grains had micro pores. Thus, water easily permeated during restoration and excellent restoration characteristics were obtained.

### Example 5

A control group was prepared by drying only with a standing hot current drier during a drying process, and an experimental group was prepared by drying with a standing hot current drier and then a rotating hot current drier during a drying process. In each case, a time taken until a water content of pre-gelatinized rice was reduced to 10% or less was measured. The drying times in each case is shown in Table 2.

TABLE 2

| | Drying | Drying time(h) | | Total Drying |
|---|---|---|---|---|
| | Temperature | Standing | Rotating | time |
| | (° C.) | type | type | (h) |
| Control group | 60 | 6 | 0 | 6 |
| Experimental | 60 | 3 | 1 | 4 |
| Group | | | | |

As shown in Table 2, when only a standing hot current drier was used, the total drying time was 6 hours, on the other hand, when a standing hot current drier and a rotating hot current drier were used, the drying time was reduced to 4 hours. Although the rotating hot current drier has a high drying efficiency, when used for pre-gelatinized rice, the pre-gelatinized rice were blown to walls of the rotating hot current drier, which causes problems for use in the first-drying. Accordingly, when water at the surface of pre-gelatinized rice was removed by using a stranding hot current drier and then the dried rice was transferred to a rotating hot current drier, pre-gelatinized rice grains did not stick to the walls and high drying efficiency was obtained.

### Example 6

Dried pre-gelatinized rice according to an embodiment of the present invention was mixed with dried vegetables and hot pepper paste to make Bibimbap (a Korean dish), and a sensory test was conducted with 50 participants.

First, in order to prepare dried pre-gelatinized rice, polished rice from which external surface materials were removed by using a rice washer was transferred to an immersion tank and immersed in hot-temperature water at 40° C. to 70° C. for 1 to 4 hours. Then, the immersion water was exchanged to cold water at a temperature of 10° C. to 30° C. and the polished rice immersed therein for 30 minutes to 2 hours. Then, the polished rice was transferred to a rotating steam cooker to remove excess immersion water and then steamed with vapor at 95° C. to 100° C. for 10 to 30 minutes. During the steaming, water was uniformly sprayed in a steam cooker once or twice. The steamed pre-gelatinized rice was uniformly spread on a wicker tray and then first dried in a standing hot current drier at a temperature of 40° C. to 90° C. for 2 to 4 hours and the first dried pre-gelatinized rice was passed through a roller and second-dried in a rotating hot current drier at a temperature of 40° C. to 90° C. for 1 to 2 hours. The water content in the pre-gelatinized rice when the drying process was finished was 5 to 20% based on weight. The dried pre-gelatinized rice was ground by using a grinder and then passed through a sorter equipped with a mesh to select separated rice grains. Then, the selected rice grains were puffed by using a puffing machine, at a temperature of 200° C. to 300° C. for 5 to 30 seconds, thereby completing preparation of dried pre-gelatinized rice. 160 g of water was added to 80 g of the dried pre-gelatinized rice and cooking was performed in a microwave oven, or hot water was added to the dried pre-gelatinized rice to restore it into pre-gelatinized rice. The restored pre-gelatinized rice was provided in the form of Bibimbap to the 50 participants.

During the sensory test, commercially available, ready-to-eat dried pre-gelatinized rice was provided as a control group. The sensory test was performed in terms of the appearance of rice grains, chewing texture, firm consistency, and overall taste.

As a result of the sensory test, dried pre-gelatinized rice prepared according to an embodiment of the present invention had better appearance, chewing properties, and overall flavor then the control group. The sensory test results are shown in Table 3.

TABLE 3

| | Appearance | | | |
|---|---|---|---|---|
| | of rice | Sense of | Firm | Overall |
| | grains | chewing | consistency | taste |
| Commercially | 2.93 | 2.29 | 2.21 | 2.84 |
| available dried | | | | |
| pre-gelatinized rice | | | | |
| Dried | 3.48 | 3.42 | 3.43 | 3.47 |
| pre-gelatinized rice | | | | |
| according to an | | | | |
| embodiment of the | | | | |
| present invention | | | | |

* The sensory test results are evaluated on a scale of 1 to 5.

A method according to the present invention is efficiently performed for a short period of time compared to a conventional method, and provides dried pre-gelatinized rice with excellent restoration characteristics and a good texture without use of additives.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing dried pre-gelatinized rice, the method comprising:
(a) washing polished rice;
(b) immersing the washed polished rice in high-temperature water at 40° C. to 70° C. of;
(c) immersing the polished rice that was immersed in the high-temperature water in low-temperature water at 10° C. to 30° C.;
(d) dehydrating the polished rice immersed in the low-temperature water to remove excess water;
(e) steaming the dehydrated polished rice, thereby preparing pre-gelatinized rice;
(f) drying the pre-gelatinized rice;
(g) separating the dried pre-gelatinized rice into individual rice grains; and
(h) puffing the separated rice grains.

2. The method of claim 1, wherein in step (b), the washed polished rice is immersed in the high-temperature water for 1 hour to 4 hours.

3. The method of claim 1, wherein in step (c), the polished rice that was immersed in the high-temperature water is immersed in the low-temperature water for 30 minutes to 2 hours.

4. The method of claim 1, wherein in step (e), the steaming is performed using steam at 95° C. to 100° C. in a steam cooker for 10 minutes to 30 minutes, and the steaming comprises uniformly spraying water on the rice.

5. The method of claim 1, wherein in step (f), the pre-gelatinized rice is uniformly spread and first dried in a standing hot current drier at a temperature of 40 to 90° C., and the first dried pre-gelatinized rice is pressed by passing it through a rolling miller with micro protrusions on the surface, and then the pressed pre-gelatinized rice is second-dried in a rotating hot current drier at a temperature of 40 to 90° C.

6. The method of claim 5, wherein the first-drying is performed for 2 to 4 hours, and the second-drying is performed for 1 to 2 hours.

7. The method of claim 1, wherein in step (g), the second-dried pre-gelatinized rice is ground by passing it through a grinder and then separated by passing it through a sorter.

8. The method of claim 1, wherein in step (h), the puffing is performed at a temperature of 200 to 300° C. for 5 to 30 seconds.
